(19) United States
(12) Patent Application Publication
(10) Pub. No.: US 2013/0173554 A1
(43) Pub. Date: Jul. 4, 2013

(54) COMPUTER PRODUCT, BACKUP CONTROL METHOD, AND BACKUP CONTROL DEVICE

(71) Applicant: FUJITSU LIMITED, Kawasaki-shi (JP)

(72) Inventor: Tomohiro UBUKATA, Ota (JP)

(73) Assignee: FUJITSU LIMITED, Kawasaki-shi (JP)

(21) Appl. No.: 13/658,409

(22) Filed: Oct. 23, 2012

(30) Foreign Application Priority Data
Dec. 28, 2011 (JP) 2011-289995

(51) Int. Cl. G06F 17/30

(52) U.S. Cl. 707/640; 707/E17.005

(57) ABSTRACT

A computer-readable recording medium stores a program that causes a computer to execute a backup control process that includes transmitting to a controlled device, a backup command to back up target data stored in the controlled device having a backup unit that backs up data while associating the data with identification information of duplicated data that is a copy of the data, and a transmission request to transmit duplicated data of the target data; and storing the duplicated data to a storage unit while associating the duplicated data with the identification information concerning the duplicated data upon receiving the duplicated data and the identification information concerning the duplicated data as a result of transmitting the backup command and the transmission request.

### CROSS REFERENCE TO RELATED APPLICATIONS

This application is based upon and claims the benefit of priority of the prior Japanese Patent Application No. 2011-289995, filed on Dec. 28, 2011, the entire contents of which are incorporated herein by reference.

### FIELD

The embodiments discussed herein are related to backup control.

### BACKGROUND

There is conventionally known a technique for storing backup data of data that is stored in a backup target machine in a device other than the backup target machine in case of data anomaly such as data corruption or computer virus infection. When the data anomaly occurs, a repair operation is performed on the data to which the data anomaly occurs by using the backup data stored in the other device.

Examples of related conventional techniques include a technique for determining whether control data or check data is abnormal by the comparison of the control data with the check data, and repairing the abnormal data. For an example, refer to Japanese Laid-Open Patent Publication No. H8-95868.

However, the conventional techniques have a problem in that when the data anomaly occurs to the backup data stored in the other device, it is difficult to perform the repair operation in a case where data anomaly occurs to the data stored in the backup target machine, for example.

### SUMMARY

According to an aspect of an embodiment, a computer-readable recording medium stores a program that causes a computer to execute a backup control process that includes transmitting to a controlled device, a backup command to back up target data stored in the controlled device having a backup unit that backs up data while associating the data with identification information of duplicated data that is a copy of the data, and a transmission request to transmit duplicated data of the target data; and storing the duplicated data to a storage unit while associating the duplicated data with the identification information concerning the duplicated data upon receiving the duplicated data and the identification information concerning the duplicated data as a result of transmitting the backup command and the transmission request.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram depicting an example of a backup control method according to a first embodiment;

FIG. 2 is an explanatory diagram depicting an example of a backup data repair method according to the first embodiment;

FIG. 3 is an explanatory diagram depicting an example of a system configuration of a backup system 300 according to a second embodiment;

FIG. 4 is an explanatory diagram depicting an example of a backup operation of each backup target machine M;

FIG. 5 is a block diagram of a hardware configuration of a backup server 301 according to the embodiments;

FIG. 6 is a block diagram of a hardware configuration of a backup target machine M according to the embodiments;

FIG. 7 is an explanatory diagram depicting an example of the contents of a data association table 700;

FIG. 8 is an explanatory diagram depicting an example of the contents of a file information table 800;

FIG. 9 is an explanatory diagram depicting an example of the contents of a restoration point table 900;

FIG. 10 is an explanatory diagram depicting an example of the contents of a save information table 1000;

FIG. 11 is a block diagram depicting an example of a functional configuration of the backup server 301;

FIG. 12 is a block diagram depicting an example of a functional configuration of the backup target machines M;

FIG. 13 is a flowchart depicting an example of the procedures of a backup process of the backup server 301;

FIG. 14 is a flowchart depicting an example of the procedures of a verification process of the backup server 301;

FIG. 15 is a flowchart depicting an example of the procedures of the backup process of the backup target machine M; and

FIG. 16 is a flowchart depicting the procedures of a repair-data transmission process of the backup target machines M.

### DESCRIPTION OF EMBODIMENTS

Preferred embodiments will be explained in detail with reference to the accompanying drawings.

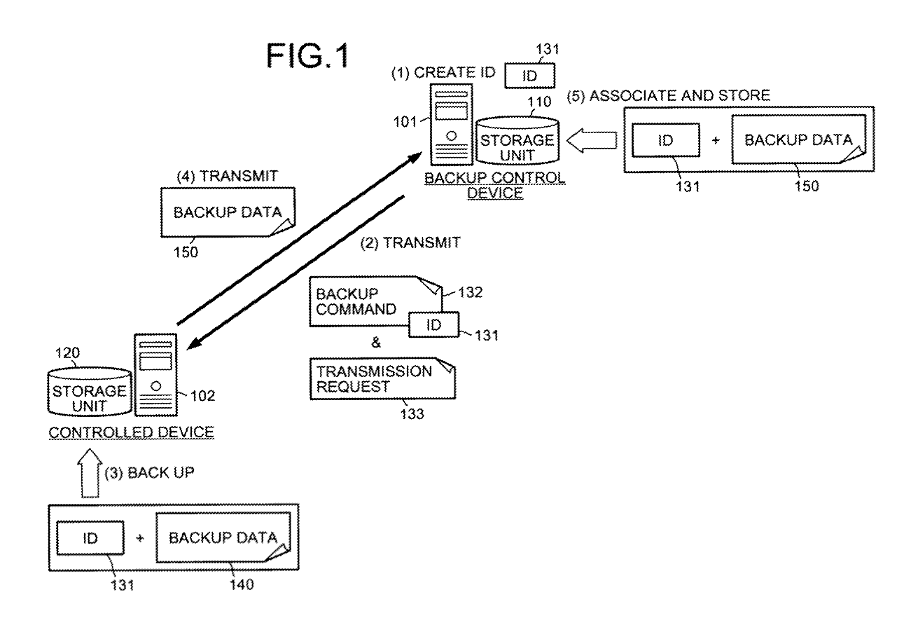

FIG. 1 is an explanatory diagram depicting an example of a backup control method according to a first embodiment. In FIG. 1, a backup control device 101 is a computer that executes a control to back up target data stored in a controlled device 102. The backup control device 101 includes a storage unit 110 and a function to back up the target data stored in the controlled device 102.

The controlled device 102 is a computer that includes a storage unit 120 and a backup unit that backs up data. When receiving a backup command to back up the target data stored in the storage unit 120 from the backup control device 101, the controlled device 102 backs up the target data by the use of the backup unit.

The backup unit backs up the data while associating the data with identification information concerning the backup data. The backup unit backs up the data by means of a snapshot function that uses a copy-on-write method, for example. The copy-on-write method is a method for generating and storing backup data of data before rewrite at a time of data rewriting.

The backup data of the data is duplicated data that is a copy of the data. For example, an identification (ID) that uniquely identifies the backup data or time point information that identifies a time point at which data backup is performed can be used as the identification information concerning the backup data.

The controlled device 102 transmits the backup data of the target data to the backup control device 101 in response to a transmission request to transmit the backup data of the target data from the backup control device 101. The backup control device 101 stores the transmitted backup data in the storage unit 110.

There are some cases where the backup data stored in the storage unit 110 is absent or damaged, resulting in data corruption. In these cases, it is impossible to use the backup data stored in the storage unit 110 to restore the data when data anomaly occurs to the data stored in the storage unit 120.

For example, it is assumed that full backup is performed on the target data at a regular interval. In this assumption, when data anomaly occurs to last full backup data, the data to which data anomaly occurs can be restored only to the data that is backed up before the last backup.

Furthermore, assuming that incremental or differential backup is performed, when data anomaly occurs to last incremental or differential backup data, the data to which the data anomaly occurs can be restored only to the data backed up at a time point before the last backup. When data anomaly occurs to the full backup data that is obtained by the full backup performed first, it is impossible to restore the data to which the data anomaly occurs.

Further, it is considered to propose that the backup control device 101 make the backup data redundant and hold the redundant backup data on an assumption that data anomaly possibly occurs to the backup data. In this case, however, the processing time and the storage capacity required for the backup control device 101 to perform a backup process disadvantageously increase.

Therefore, in the first embodiment, the backup control device 101 and the controlled device 102 separately hold backup data and make the backup data redundant by the use of the backup function of the controlled device 102. It is thereby possible for the backup control device 101 to repair the backup data to which data anomaly occurs. An example of procedures of a process for the backup control method according to the first embodiment is explained below.

(1) The backup control device 101 creates an ID 131 that uniquely identifies the backup data of the target data stored in the storage unit 120 of the controlled device 102. This ID 131 uniquely identifies backup data 150 (described later).

(2) The backup control device 101 transmits a backup command 132 to back up the target data stored in the storage unit 120 and a transmission request 133 to transmit the backup data of the target data to the backup control device 101, to the controlled device 102. For example, the backup command 132 includes the ID 131 that uniquely identifies the backup data of the target data.

(3) The controlled device 102 backs up the target data while associating the backup data with the identification information concerning the backup data of the target data by the use of the backup unit when receiving the backup command 132 and the transmission request 133. For example, the identification information concerning the backup data is the ID 131 included in the backup command 132.

For example, the controlled device 102 associates backup data 140 of the target data generated by the backup unit with the ID 131 and stores the backup data 140 in the storage unit 120. More For example, the backup unit generates the backup data 140 by copying data before rewrite at a time of initially rewriting the target data after a time point at which the controlled device 102 receives the backup command 132.

(4) The controlled device 102 transmits the backup data 150 of the target data to the backup control device 101. For example, the controlled device 102 generates the backup data 150 by copying the target data and transmits the backup data 150 to the backup control device 101 when receiving the backup command 132.

(5) The backup control device 101 associates the backup data 150 with identification information concerning the backup data 150 and stores the backup data 150 in the storage unit 110 when receiving the backup data 150. The identification information concerning the backup data 150 is the ID 131 included in the backup command 132, for example.

In this way, according to the backup control method of the present embodiment, both the backup control device 101 and the controlled device 102 can hold the backup data 150 and 140, respectively by the use of the backup unit included in the controlled device 102.

Accordingly, the backup data of the target data stored in the storage unit 120 of the controlled device 102 can be made redundant. Furthermore, as compared with a case where the backup data is made redundant and the redundant backup data is held in the backup control device 101, it is possible to reduce the processing time and the storage capacity required for the backup control device 101 to perform the backup process.

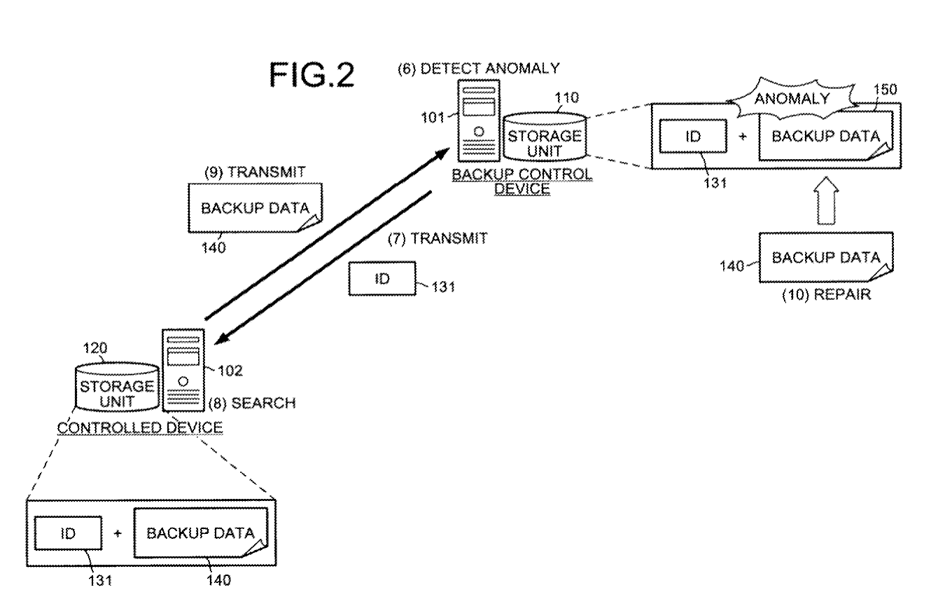

An example of a backup data repair method according to the first embodiment is explained next. FIG. 2 is an explanatory diagram depicting an example of the backup data repair method according to the first embodiment. The backup data repair method is described while referring to a case where data anomaly occurs to the backup data 150 stored in the storage unit 110 of the backup control device 101 as an example.

(6) The backup control device 101 detects the backup data 150 that is stored in the storage unit 110 and to which data anomaly occurs. The data anomaly refers to a state, for example, where the backup data 150 is absent, damaged, or unreadable for some reason and where it is impossible to restore the target data.

(7) When detecting that data anomaly occurs to the backup data 150, the backup control device 101 transmits the ID 131 stored in the storage unit 110 while associating the ID 131 with the backup data 150 to the controlled device 102. To transmit the ID 131 signifies an acquisition request to acquire repair data for repairing the backup data 150.

(8) When receiving the ID 131, the controlled device 102 searches the storage unit 120 for the backup data that is backed up while being associated with the ID 131. In this example, the controlled device 102 searches for the backup data 140 stored in the storage unit 120 while being associated with the ID 131.

(9) The controlled device 102 transmits the retrieved backup data 140 to the backup control device 101.

(10) Upon receiving the backup data 140, the backup control device 101 repairs the backup data 150 to which data anomaly occurs by using the backup data 140.

In this way, according to the backup data repair method of the present embodiment, when the data anomaly occurs to the backup data 150, the backup control device 101 can repair the backup data 150 by using the backup data 140 stored in the storage unit 120 of the controlled device 102.

Accordingly, in a case where data anomaly subsequently occurs to the target data stored in the storage unit 120, the backup control device 101 can repair the target data by using the backup data that is repaired by using the backup data 140. While it has been explained above that the ID 131 created by the backup control device 101 is used as the identification information concerning the backup data 150, the identification information concerning the backup data 150 is not limited to the ID 131.

For example, time point information representing a time of receipt at which the controlled device 102 receives the backup command 132 can be used as the identification information concerning the backup data 150. In this case, the controlled device 102 transmits the backup data 150 as well as the time point information to the backup control device 101 in the section (4). In the section (5), the backup control device 101 stores the backup data 150 in the storage unit 110 while associating the backup data 150 with the time point information. As a result, the backup data 140 and 150 can be made to correspond to each other by the use of the time point information that represents the time of receipt of the backup command 132. In this case, it is unnecessary to create the ID 131 in the section (1).

For example, if the backup control device 101 and the controlled device 102 are temporally synchronized, the backup control device 101 can use time point information that represents a time of transmission of the backup command 132 as the identification information concerning the backup data 150. Furthermore, the controlled device 102 can use the time point information that represents the time of receipt of the backup command 132 as the identification information concerning the backup data 150. It is assumed here that the time of transmission of the backup command 132 is substantially the same as the time of receipt of the backup command 132. As a result, the backup data 140 and 150 can be made to correspond to each other using the time point information that represents the time of transmission of the backup command 132 and the time point information that represents the time of receipt thereof. In this case, it is unnecessary to create the ID 131 in the section (1).

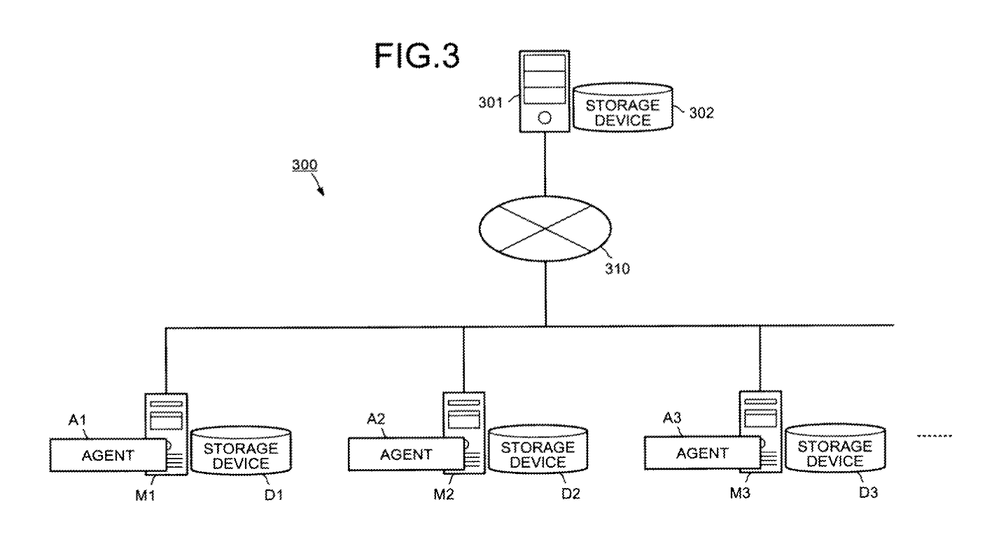

An example of a system configuration of a backup system 300 according to a second embodiment is explained next. The backup system 300 is explained while referring to a case where the backup control device 101 depicted in FIGS. 1 and 2 is applied to a backup server 301 included in the backup system 300 depicted in FIG. 3 and where and the controlled device 102 depicted in FIGS. 1 and 2 is applied to each of backup target machines M included in the backup system 300 depicted in FIG. 3 as an example. Explanations of components identical to those described in the first embodiment will be omitted.

FIG. 3 is an explanatory diagram depicting an example of the system configuration of the backup system 300 according to the second embodiment. In FIG. 3, the backup system 300 includes the backup server 301 and multiple backup target machines (backup target machines M1 to M3, for example).

In the backup system 300, the backup server 301 is communicably connected to the backup target machines M via a wired or wireless network 310. For example, the network 301 is the LAN (Local Area Network), the WAN (Wide Area Network), or the Internet.

The backup server 301 is a computer that includes a storage device 302 and that backs up target data stored in storage devices D (storage devices D1 to D3, for example) of the respective backup target machines M. For example, the backup server 301 acquires the backup data from each of the backup target machines M by transmitting a transmission request to transmit the backup data to the backup target machine M.

For example, the target data is information stored in a storage area used by an operating system (OS) of each of the backup target machines M among storage areas of the storage device D. For example, the target data includes information concerning how the storage device D is partitioned, the OS, applications, and the like.

Furthermore, the backup server 301 includes a function to execute a control to back up the target data stored in the storage device D of each of the backup target machines M. For example, the backup server 301 instructs each backup target machine M to back up the target data by transmitting a backup command to back up the target data to the backup target machine M.

Alternatively, the backup server 301 can include a function to restore the target data stored in the storage device D of each of the backup target machines M. “To restore” means “to restore the target data to which data anomaly occurs by using the backup data when the data anomaly occurs to the target data”.

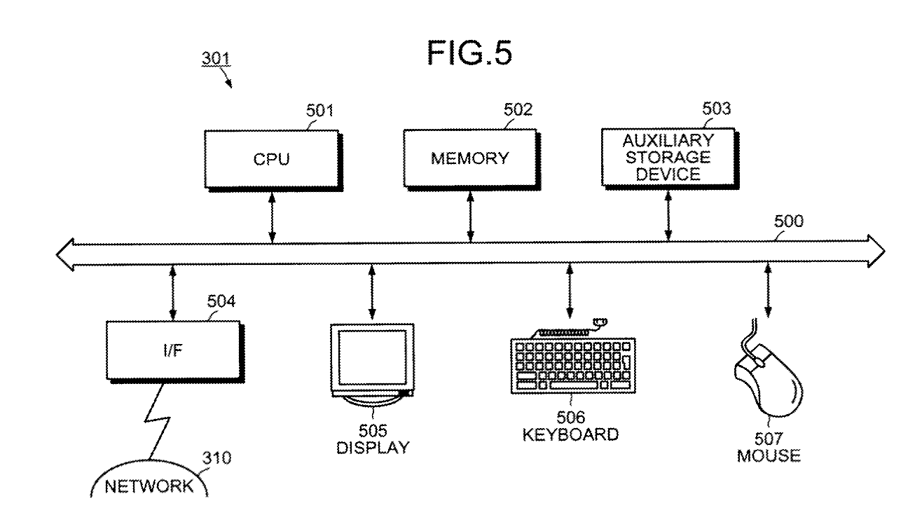

As a backup method adopted by the backup server 301, an arbitrary method selected from among the full backup, the incremental backup, and the differential backup can be adopted. For example, the storage device 302 is realized by a memory 502, an auxiliary storage device 503, or the like depicted in FIG. 5 (described later).

Each of the backup target machines M is a computer that includes the storage device D and that includes the snapshot function using the copy-on-write method. The backup target machine M also includes a function to generate the backup data of the target data stored in the storage device D and to transmit the generated backup data to the backup server 301.

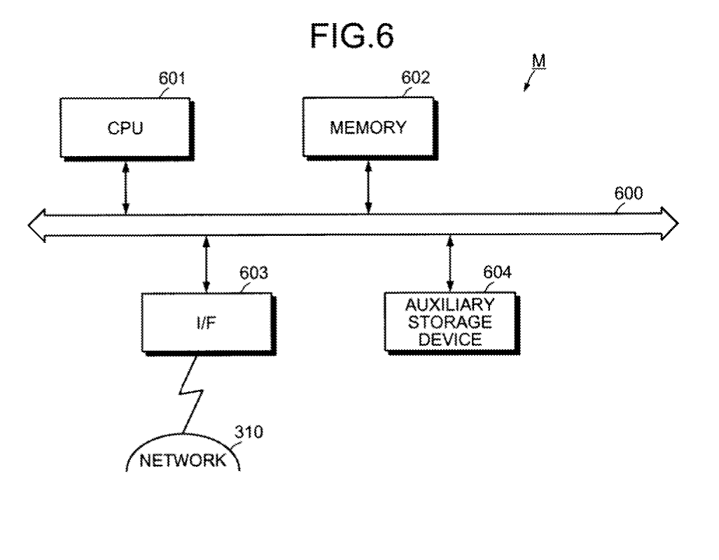

The storage area for the backup is provided in the storage device D. For example, the storage device D is realized by a memory 602, an auxiliary storage device 604, or the like depicted in FIG. 6 (described later). Alternatively, it suffices that the storage device D is a storage device to which the backup target machine M is accessible via the storage area network (SAN).

In this case, agents (agents A1 to A3, for example) that are software for communicating with the backup server 301 are installed into the backup target machines M, respectively.

For example, when one of the backup target machines M receives the transmission request to transmit the backup data from the backup server 301, the agent A generates the backup data of the target data stored in the storage device D. For example, the agent A then compresses the generated backup data and transmits the compressed backup data to the backup server 301 in units of blocks.

In this case, the backup server 301 can generate a backup image and store the backup image in the storage device 302 by merging together the received backup data in units of blocks. The backup image is one file included the compressed backup image.

Furthermore, when one of the backup target machines M receives a backup command from the backup server 301, for example, the agent A generates a restoration point. The restoration point is intended to restore a state of the backup target machine M to a state at a time point of generating the restoration point. An example of an operation performed by the backup target machine M that backs up data using the restoration point is explained below.

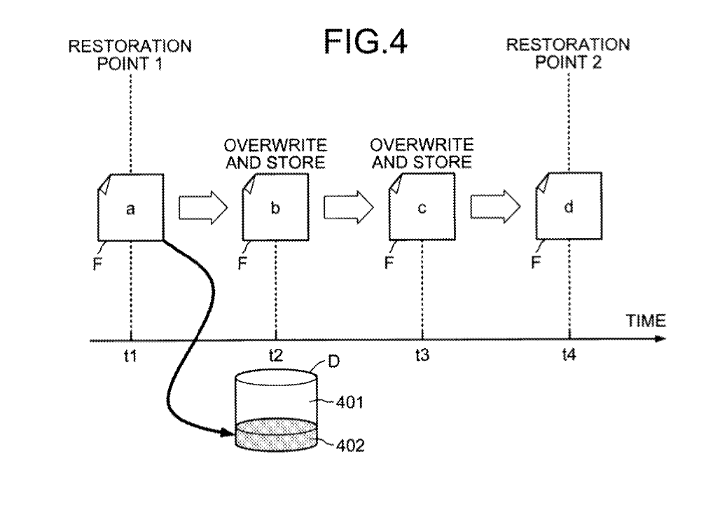

FIG. 4 is an explanatory diagram depicting an example of a backup operation performed by the snapshot function of each of the backup target machines M using the copy-on-write method. FIG. 4 depicts a file F as the target data and a transition in the contents of the file F along a time axis. The file F is information stored in a storage area 401 included in the storage device D of the backup target machine M.

First, at a time t1, when the agent A generates a restoration point 1, the snapshot function using the copy-on-write method holds a state of the file F at the time t1 at which the restoration point 1 is generated. Alternatively, the agent A can fulfill this function. It is assumed that, at a time t2, a content ‘a’ of the file F changes to a content ‘b’ and the content ‘b’ is overwritten on the content ‘a’ and stored.

In this case, at the time t2, the snapshot function using the copy-on-write method saves backup data of the file F (content ‘a’) at the time t1 in a storage area 402 for backup in the storage device D. Alternatively, the agent A can fulfill this function. It is thereby possible to subsequently restore the file F (content ‘a’) at the time t1 at which the restoration point 1 is generated.

It is assumed here that it is impossible to restore the content of the file F that changes between multiple restoration points. In the example depicted in FIG. 4, the content of the file F changes twice at the time t2 and a time t3 between the time t1 at which the restoration point 1 is generated and a time t4 at which a restoration point 2 is generated. In this case, it is impossible to restore contents ‘b’ and ‘c’ of the file F at the times t2 and t3 from the restoration points 1 and 2, respectively.

FIG. 5 is a block diagram of a hardware configuration of the backup server 301 according to the embodiments. As depicted in FIG. 5, the backup server 301 includes a central processing unit (CPU) 501, memory 502, an auxiliary storage device 503, an interface (I/F) 504, a display 505, keyboard 506, and a mouse 507, respectively connected by a bus 500.

The CPU 501 governs overall control of the backup server 301. The memory 502 includes read-only memory (ROM), random access memory (RAM), and flash ROM. The ROM and flash ROM, for example, store therein various types of programs of applications and the like. The RAM is used as a work area of the CPU 501.

The auxiliary storage device 503 is a storage device storing data and under the control of the CPU 501, performs the reading and writing of data. The auxiliary storage device 503 is realized by, for example, a magnetic disk, an optical disk, magnetic tape, flash memory, and the like.

The I/F 504 is connected to the network 310 through a communication line and is connected to other apparatuses through the network 310. The I/F 504 administers an internal interface with the network 310 and controls the input/output of data from/to external apparatuses. For example, a modem or a LAN adaptor may be employed as the I/F 504.

The display 505 displays, for example, data such as text, images, functional information, etc., in addition to a cursor, icons, and/or tool boxes. A cathode ray tube (CRT), a thin-film-transistor (TFT) liquid crystal display, a plasma display, etc., may be employed as the display 505.

The keyboard 506 includes, for example, keys for inputting letters, numerals, and various instructions and performs the input of data. The mouse 507 is used to move the cursor, select a region, or move and change the size of windows. In addition to the components above, the backup server 301 may also have, for example, a scanner and a printer.

FIG. 6 is a block diagram of a hardware configuration of the backup target machine M according to the embodiments. As depicted in FIG. 6, the backup target machine M includes a central processing unit (CPU) 601, memory 602, an interface (I/F) 503, and an auxiliary storage device 604, respectively connected by a bus 600.

The CPU 601 governs overall control of the backup target machine M. The memory 602 includes ROM, RAM, and flash ROM. The ROM and flash ROM, for example, store therein various types of programs of applications and the like. The RAM is used as a work area of the CPU 601.

The I/F 603 is connected to the network 310 through a communication line and is connected to other apparatuses through the network 310. The I/F 603 administers an internal interface with the network 310 and controls the input/output of data from/to external apparatuses. For example, a modem or a LAN adaptor may be employed as the I/F 603.

The auxiliary storage device 604 is a storage device storing data and under the control of the CPU 601, performs the reading and writing of data. The auxiliary storage device 604 is realized by, for example, a magnetic disk, an optical disk, magnetic tape, flash memory, and the like. In addition to the components above, the backup target machine M may also have, for example, a display, keyboard, and mouse.

Contents of a data association table 700 used by the backup server 301 is explained next. For example, the data association table 700 is realized by the memory 502 or the auxiliary storage device 503 of the backup server 301 depicted in FIG. 5.

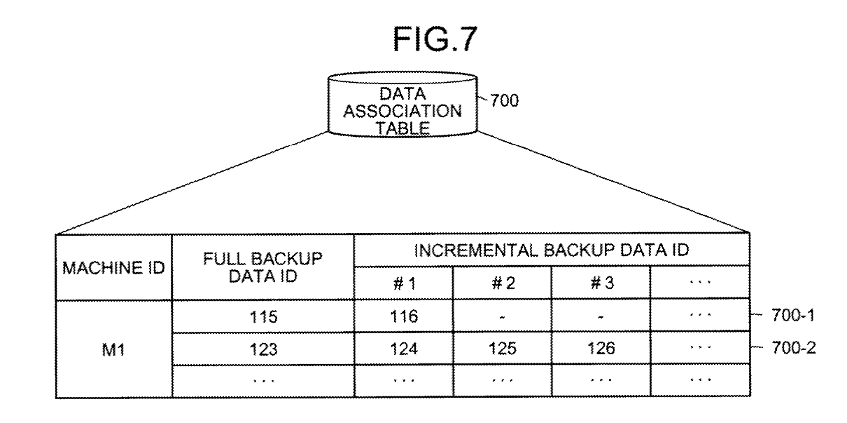

FIG. 7 is an explanatory diagram depicting an example of the contents of the data association table 700. In FIG. 7, the data association table 700 includes machine ID fields, full backup data ID fields, and incremental backup data ID fields. By setting information to each of the fields, associated information (associated information 700-1 and 700-2, for example) is stored in the data association table 700 as records.

A machine ID is an identifier of each of the backup target machines M. The identifier of the backup target machine M is explained while referring to a case where the ID 131 that uniquely identifies the backup data of the target data depicted in FIGS. 1 and 2 is applied as the data ID of the backup data as an example. A full backup data ID is a data ID of the backup data that is full backup data. An incremental backup data ID is a data ID of the backup data that is incremental backup data. In FIG. 7, the number after “#” denotes an order in which an incremental backup is performed. For example, “#2” means a second incremental backup.

As for the associated information 700-2 as an example, FIG. 7 depicts data ID “124, 125, and 126” of first to third incremental backup data obtained by the first to third incremental backups performed after the full backup while associating the data ID “124, 125, and 126” with a full backup data ID “123” of the backup target machine M1.

Contents of a file information table 800 used by the backup server 301 is explained next. For example, the file information table 800 is generated for every backup data stored in each of the backup target machines M. For example, the file information table 800 is realized by the memory 502 or the auxiliary storage device 503 of the backup server 301.

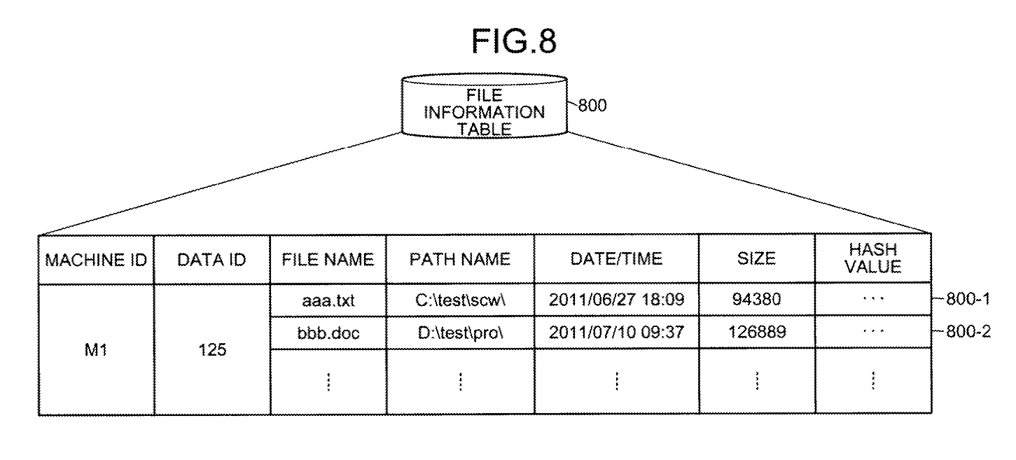

FIG. 8 is an explanatory diagram depicting an example of the contents of the file information table 800. In FIG. 8, the file information table 800 includes a data ID field, a file name field, a path name field, a date/time field, a size field, and a hash value field. By setting information to each of the fields, file information (file information 800-1 and 8002, for example) on respective files is stored in the file information table 800 as records. These fields are given only for illustrated purposes and the other information can be used for identifying the files.

The machine ID is the identifier of each of the backup target machines M. The identifier of the backup target machine M is explained while referring to a case where the ID 131 that uniquely identifies the backup data of the target data depicted in FIGS. 1 and 2 is applied as the data ID of the backup data as an example. A file name is a name of each file included in the backup data. A path name is a name of a path that indicates a storage location at which each file is stored on each backup target machine M. A date is a last update date of each file. A size is a data size (bytes in units) of each file. A hash value is a fixed-length pseudorandom number obtained by assigning the contents of each file to a hash function.

As for the file information 800-2 as an example, FIG. 8 depicts a file name “bbb.doc”, a path name “D:¥test¥pro¥”, a date “2011 Jul. 10 09:37”, a size “126,889”, and a hash value “ . . . ” (a value obtained by the hash function) of a file included in the backup data having the data ID “125” (hereinafter, also simply “backup date 125”) of the backup target machine M1.

Contents of a restoration point table 900 used by each of the backup target machines M is explained next. For example, the restoration point table 900 is realized by the memory 602 or the auxiliary storage device 604 of the backup target machine M depicted in FIG. 6. The restoration point table 900 used by the backup target machine M1 is explained below as an example.

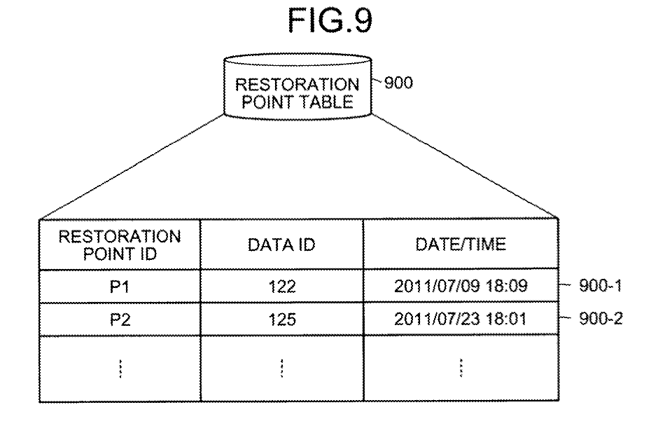

FIG. 9 is an explanatory diagram depicting an example of the contents of the restoration point table 900. In FIG. 9, the restoration point table 900 includes a restoration point ID field, a data ID field, and a date/time field. By setting information to each of the fields, restoration point information (restoration point information 900-1 and 900-2, for example) on the respective restoration points is stored in the restoration point table 900 as records.

A restoration point ID is an identifier of each of the restoration points. The restoration point ID is explained while referring to a case of applying the ID 131 that uniquely identifies the backup data of the target data depicted in FIGS. 1 and 2 as the data ID of the backup data as an example. A date is a data at which each restoration point is generated. As for the restoration point information 900-2 as an example, FIG. 9 depicts the data ID “125” of the backup data associated with a restoration point having a restoration point ID “P2” and a date “2011 Jul. 23 18:01” at which the restoration point having the restoration point ID “P2” is generated.

Contents of a save information table 1000 used by each of the backup target machines M is explained next. For example, the save information table 100 is realized by the memory 602 or the auxiliary storage device 604 of the backup target machine M depicted in FIG. 6. The save information table 1000 used by the backup target machine M1 is explained below as an example.

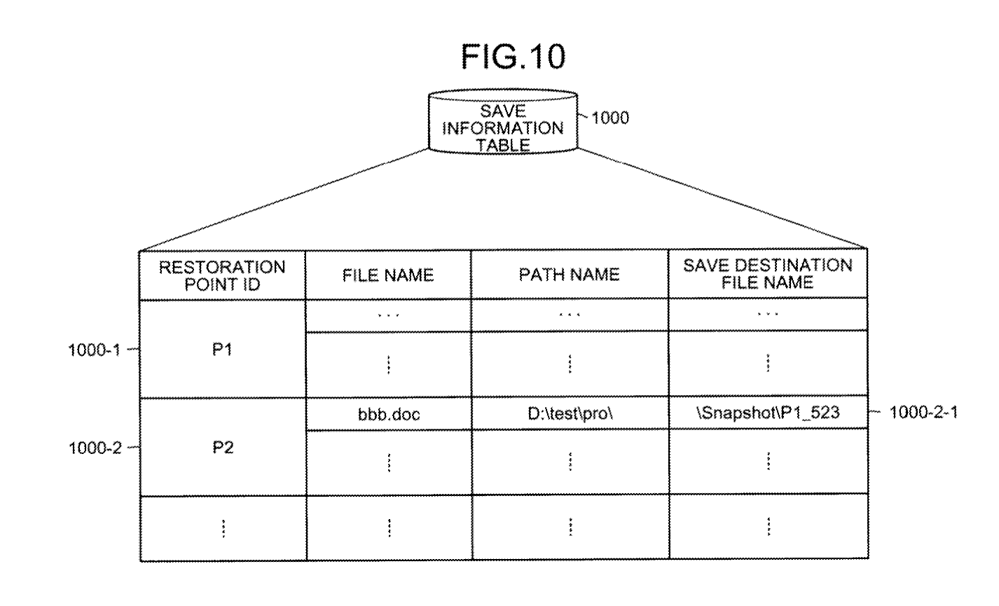

FIG. 10 is an explanatory diagram depicting an example of the contents of the save information table 1000. In FIG. 10, the save information table 1000 includes a restoration point ID field, a file name field, a path name field, and a save destination name field. By setting information to each field, save information (save information 1000-1 and 1000-2, for example) on the respective restoration points is stored in the save information table 1000 as records.

The restoration point ID is the identifier of each restoration point. A file name is a name of a saved file. The saved file is the target data updated after a time point at which each restoration point is generated. The path name is the name of the path that indicates the storage location at which each saved file is stored on each backup target machine M. A save destination file name is a file name of the saved file stored in the storage area 402 for backup (see FIG. 4) in the storage device D.

As for the save information 1000-2 as an example, the save information 1000-2 includes save information 1000-2-1 generated as a result of updating the file having the file name “bbb.doc” after a time point at which the restoration point P2 is generated. As for the save information 1000-2-1, FIG. 10 depicts the path name “D:¥test¥pro¥” of the file having the file name “bbb.doc” and a save destination file name “¥Snapshot¥P1_{—}523”.

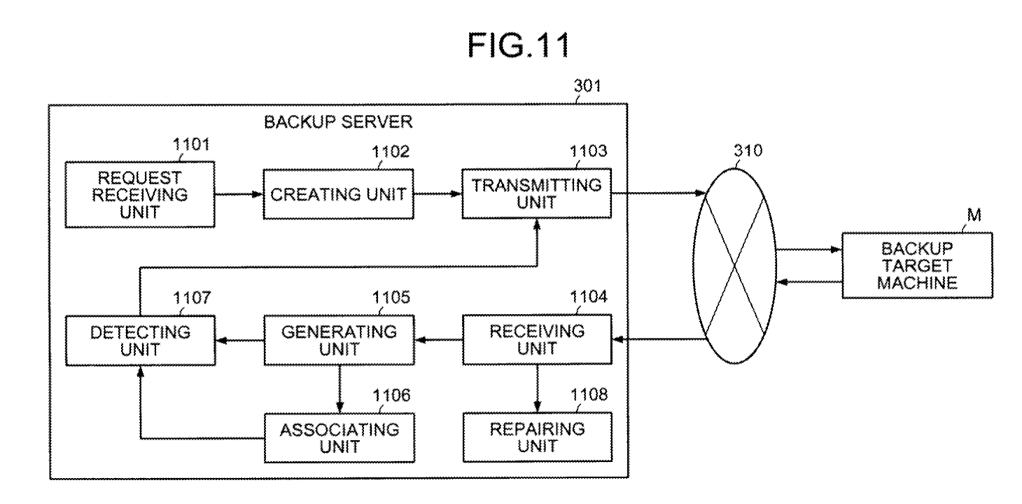

An example of a functional configuration of the backup server 301 is explained next. FIG. 11 is a block diagram depicting an example of the functional configuration of the backup server 301. In FIG. 11, the backup server 301 is configured to include a request receiving unit 1101, a creating unit 1102, a transmitting unit 1103, a receiving unit 1104, a generating unit 1105, an associating unit 1106, a detecting unit 1107, and a repairing unit 1108. The functional units from the request receiving unit 1101 to the repairing unit 1108 include functions serving as a controller. Functions of the request receiving unit 1101 to the repairing unit 1108 are realized by causing, for example, the CPU 501 to execute a backup control program stored in the memory 502, the auxiliary storage device 503, or the like depicted in FIG. 5 or by the I/F 504. Results of processes performed by the respective functional units are stored in the memory 502 or the auxiliary storage device 503, for example.

The request receiving unit 1101 includes a function to accept a backup request to back up the target data stored in the storage device D of one of the backup target machines M. For example, the backup request includes information indicating the machine ID and the backup method of the backup target machine M. A case of using the incremental backup as the backup method is explained below as an example.

For example, the request receiving unit 1101 accepts the backup request to back up the target data in response to a user's operation and input using the keyboard 506, the mouse 507, and the like depicted in FIG. 5. Alternatively, the request receiving unit 1101 can accept the backup request to back up the target data from an external computer.

The creating unit 1102 includes a function to create the data ID that uniquely identifies the backup data of the target data.

The transmitting unit 1103 transmits the backup command (hereinafter, “backup command R1”) to back up the target data and a transmission request (hereinafter, “transmission request R2”) to transmit the backup data of the target data to the backup target machine M. For example, the backup command R1 includes the created data ID, information for identifying the target data, and information for identifying the backup method.

The transmission request R2 includes the information for identifying the target data and the information for identifying the backup method, for example. Note that the backup target machine M to which the transmitting unit 1103 transmits the backup command R1 and the transmission request R2 can be identified from the accepted backup request, for example.

The receiving unit 1104 includes a function to receive the backup data of the target data from the backup target machine M as a result of transmission of the backup command R1 and the transmission request R2 to the backup target machine M. For example, the receiving unit 1104 receives the compressed backup data from the backup target machine M in units of blocks.

The generating unit 1105 includes a function to generate the backup image of the target data based on the received backup data of the target data. For example, the generating unit 1105 generates one file by merging together the received backup data in units of blocks, thereby making it possible to manage the backup data as the backup image of the target data based on the data ID. Unless otherwise specified, the backup data is explained below while the backup data includes the meaning of the backup image.

The generating unit 1105 generates the file information concerning each file of the target data based on the backup data. The file information is the information included the file name, the path name, the date, the size, the hash value, and the like of each file as depicted in FIG. 8.

The associating unit 1106 includes a function to associate the backup data and the data ID created by the creating unit 1102. For example, the associating unit 1106 stores the generated file information concerning each file in the file information table 800 while associating the file information with the machine ID of the backup target machine M and the data ID of the backup data.

The associating unit 1106 also includes a function to associate the data ID of the backup data with those of the other backup data associated with the backup data. For example, if the backup data is the full backup data, the associating unit 1106 does not associate the data ID of the backup data with those of the other backup data because no incremental backup data is generated.

On the other hand, if the generated backup data is the incremental backup data, the associating unit 1106 associates the data ID of the backup data with those of the other incremental backup data. For example, the associating unit 1106 stores the data ID of the incremental backup data in the data association table 700 while associating the data ID of the incremental backup data with the machine ID of the backup target machine M, the data ID of the full backup data, and the data ID of the other incremental backup data.

Processes performed by the functional units for repairing data that is included in the backup data and to which data anomaly occurs is explained next.

The detecting unit 1107 includes a function to detect the data to which data anomaly occurs from the backup data. For example, the detecting unit 1107 can detect the data that is absent, damaged, or unreadable from the backup data in units of files.

An example of the process performed by the detecting unit 1107 is explained below while referring to a case of detecting the data to which data anomaly occurs from the backup data having the backup data ID “125” stored in the backup target machine M1 as an example.

For example, the detecting unit 1107 first selects the file information from the file information table 800 depicted in FIG. 8. The detecting unit 1107 next searches the file having the file name in the selected file information in the backup data 125. When no file is searched, the detecting unit 1107 detects the file having the file name included in the selected file information as the data to which data anomaly occurs.

On the other hand, when the file is retrieved, the detecting unit 1107 compares the date, the size, and the hash value included in the selected file information with those of the retrieved file. When these values do not match one another, the detecting unit 1107 detects the file having the file name included in the selected file information as the data to which data anomaly occurs. Conversely, when these values match one another, the detecting unit 1107 determines that the file having the file name included in the selected file information is normal. Because a method of detecting the data to which data anomaly occurs is given only for illustrative purposes, the other method or the other values can be used for detecting the data to which data anomaly occurs.

The detecting unit 1107 repeatedly performs a series of procedures of the process described above until no unselected file information that is not selected yet from the backup data 125 is present. The detecting unit 1107 can thereby detect the data to which data anomaly occurs from the backup data 125 in units of files.

Furthermore, the detecting unit 1107 can identify the other backup data associated with the backup data 125 when detecting the data to which data anomaly occurs from the backup data 125. For example, the detecting unit 1107 identifies the other backup data associated with the backup data 125 while referring to the data association table 700 depicted in FIG. 7.

For example, if the backup data to which data anomaly occurs is the backup data 125, the detecting unit 1107 identifies the other backup data having the data ID “123, 124, and 126” (hereinafter, also simply “backup data 123, 124, and 126”) associated with the backup data 125 while referring to the data association table 700.

When the detecting unit 1107 detects the data to which data anomaly occurs, the transmitting unit 1103 transmits an acquisition request (hereinafter, “acquisition request R3”) to acquire the repair data for repairing the data to the backup target machine M. For example, the acquisition request R3 includes the file information concerning the data to which data anomaly occurs. For example, the acquisition request R3 includes the data ID of the backup data, and the file name, the path name, the date, the size, and the hash value of the file to which data anomaly occurs.

Alternatively, the acquisition request R3 can include, for example, the data ID (hereinafter, “associated data ID”) of the other backup data associated with the backup data 125 to which data anomaly occurs. The backup target machine M to which the transmitting unit 1103 transmits the acquisition request R3 can be identified from the file information concerning the data to which data anomaly occurs.

The receiving unit 1104 includes a function to receive the repair data for repairing the data to which data anomaly occurs as a result of the transmission of the acquisition request R3. The repair data is data identified from the acquisition request R3 among the data backed up in the storage area 402 of the storage device D of the backup target machine M.

For example, the repair data is the data identified from the file name, the path name, the date, the size, and the hash value included in the acquisition request R3 among the data backed up to be associated with the data ID of the backup data included in the acquisition request R3.

The repairing unit 1108 includes a function to repair the data to which data anomaly occurs when the receiving unit 1104 receives the repair data. For example, the repairing unit 1108 overwrites the repair data on the storage area of the storage device 302 in which the data to which data anomaly occurs is stored, thereby repairing the data to which data anomaly occurs.

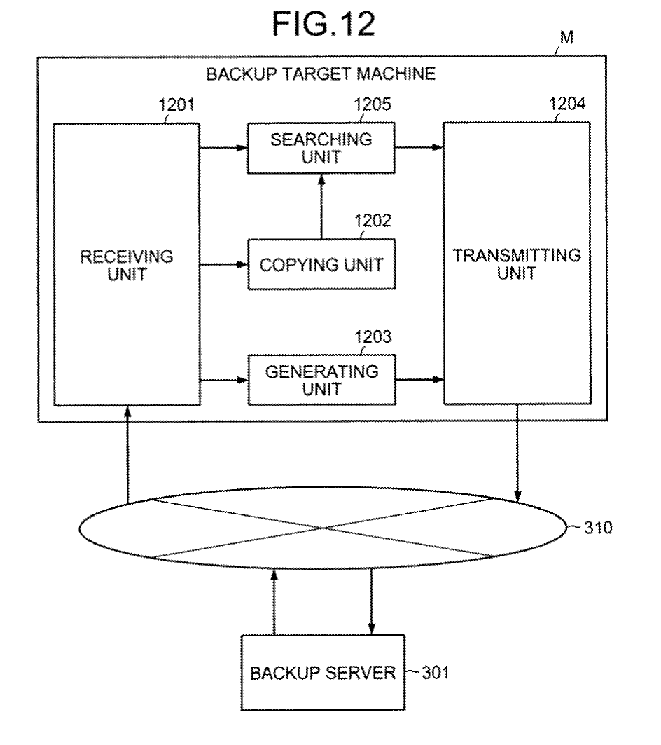

An example of a functional configuration of each of the backup target machines M is explained next. FIG. 12 is a block diagram depicting an example of the functional configuration of each of the backup target machines M. In FIG. 12, the backup target machine M is configured to include a receiving unit 1201, a copying unit 1202, a generating unit 1203, a transmitting unit 1204, and a searching unit 1205. The functional units from the receiving unit 1201 to the searching unit 1205 include functions serving as a controller. For example, the functions of the receiving unit 1201 to the searching unit 1205 are realized by causing the CPU 601 to execute an agent program stored in the memory 602, the auxiliary storage device 604, or the like depicted in FIG. 6 or by the I/F 603. Results of processes performed by the respective functional units are stored to the memory 602 or the auxiliary storage device 604, for example.

The receiving unit 1201 includes a function to receive the backup command R1 and the transmission request R2 from the backup server 301. As described above, the backup command R1 is the command to back up the target data. The transmission request R2 is the request to transmit the backup data of the target data.

The copying unit 1201 includes a function to back up the target data while associating the target data with the data ID on the backup data included in the backup command R1 when the receiving unit 1201 receives the backup command R1. For example, the copying unit 1202 generates a restoration point by the use of the snapshot function. At this time, the copying unit 1202 creates the restoration point ID that uniquely identifies the generated restoration point.

The copying unit 1201 registers the created restoration point ID, the data ID of the backup data included in the backup command R1, and a date at which the restoration point is generated in the restoration point table 900 depicted in FIG. 9 while associating the restoration point ID, the data ID, and the date with one another. As a result, new restoration point information is stored in the restoration point table 900 as records.

Furthermore, the copying unit 1202 stores duplicated data that is a copy of the data before update in the storage area 402 of the storage device D when the target data is updated after a time point at which the restoration point is generated. For example, the copying unit 1202 stores the files before the update as copies of saved files in the storage area 402 of the storage device D.

The copying unit 1202 registers the restoration point ID of the restoration point, the file names, the path names, and the save destination file names of the saved files in the save information table 100 depicted in FIG. 10 while associating the restoration point ID with the file names, the path names, and the save destination file names of the saved. As a result, new save information is stored in the save information table 1000 as records.

The generating unit 1203 includes a function to generate the backup data of the target data when the receiving unit 1201 receives the transmission request R2. For example, the generating unit 1203 extracts the target data from the storage device D and compresses the backup data, thereby generating the backup data in units of blocks.

The transmitting unit 1204 includes a function to transmit the generated backup data of the target data to the backup server 301. For example, the transmitting unit 1204 sequentially transmits the generated backup data in units of blocks to the backup server 301.

Contents of processes performed by the respective functional units for searching for the repair data for repairing the data to which data anomaly occurs are explained next.

The receiving unit 1201 includes a function to receive the acquisition request R3 from the backup server 301. As described above, the acquisition request R3 is the request to acquire the repair data for repairing the data to which data anomaly occurs.

The searching unit 1205 includes a function to search the repair data identified from the acquisition request R3 in the storage device D when the receiving unit 1201 receives the acquisition request R3. For example, the searching unit 1205 searches the storage device D for the data backed up and associated with the data ID included in the acquisition request R3 among the data backed up by the copying unit 1202.

The transmitting unit 1204 includes a function to transmit the searched repair data to the backup server 301. Alternatively, when the repair data is not retrieved, the searching unit 1205 can transmit an acquisition response indicating that the repair data is not retrieved to the backup server 301.

An example of specific contents of processes performed by the searching unit 1205 is explained below. It suffices that the searching unit 1205 performs at least one of first to fourth search processes explained below in an arbitrary order.

It is assumed here that the acquisition request R3 includes the data ID “125” of the backup data, the associated data ID “123, 124, and 126”, the file name “bbb.doc”, the path name “D:¥test¥pro¥”, the date “2011 Jul. 10 09:37”, the size “126,889”, and the hash value “ . . . ” (a value obtained by the hash function).

However, the copying unit 1202 is unable to unlimitedly generate restoration points because of a limit to a storage capacity of the storage area 402 in the storage device D. Therefore, the backup target machine M deletes the older restoration point when the storage capacity of the storage area 402 exceeds a specified value, for example.

When the restoration point is deleted, the restoration point information corresponding to the deleted restoration point is, for example, deleted from the restoration point table 900. Similarly, when the restoration point is deleted, the save information corresponding to the deleted restoration point is, for example, deleted from the save information table 1000.

First Search Process

First, the searching unit 1205 searches the storage area 401 of the storage device 401 for the file having the file name “bbb.doc” and the path name “D:¥test¥pro¥”. When the file is retrieved, the searching unit 1205 determines, for example, whether the size and the hash value of the retrieved file match the size “126,889” and the hash value “ . . . ” (a value obtained by the hash function), respectively.

When the sizes and the hash values match one another, the searching unit 1205 determines the retrieved file as the repair data. The searching unit 1205 can thereby search the storage area 401 of the storage device D for the repair data for repairing the file to which data anomaly occurs and that has the file name “bbb.doc” with the file name and the path name included in the acquisition request R3 used as a clue.

Second Search Process

First, the searching unit 1205 identifies the restoration point ID corresponding to the data ID “125” of the backup data included in the acquisition request R3 by referring to the restoration point table 900. In the example depicted in FIG. 9, the searching unit 1205 identifies the restoration point ID “P2” corresponding to the data ID “125”.

Next, the searching unit 1205 searches the save information table 1000 for the save information in which “P2” is set to the restoration point ID field, “bbb.doc” is set to the file name field, and “D:¥test¥pro¥” is set to the path name field. In the example depicted in FIG. 10, the save information 1000-2-1 is retrieved.

The searching unit 1205 searches the storage area 402 of the storage device D for the file having the save destination file name included in the retrieved save information 1000-2-1. The searching unit 1205 can thereby search the storage area 402 of the storage device D for the repair data for repairing the file to which data anomaly occurs and that has the file name “bbb.doc” with the data ID included in the acquisition request R3 used as a clue.

Third Search Process

The searching unit 1205 identifies the restoration point ID corresponding to the associated data ID included in the acquisition request R3 by referring to the restoration point table 900. When identifying the restoration point ID, the searching unit 1205 searches the save information table 1000 for the save information in which the restoration point ID “P2” is set to the restoration point ID field, “bbb.doc” is set to the file name field, and “D:¥test¥pro¥” is set to the path name.

The searching unit 1205 then searches the storage area 402 of the storage device D for the file having the save destination file name included in the retrieved save information. If the file is retrieved, the searching unit 1205 determines, for example, whether the size and the hash value of the retrieved file match the size “126,889” and the hash value “ . . . ” (a value obtained by the hash function), respectively.

If the sizes and the hash values match one another, the searching unit 1205 determines the retrieved file as the repair data. The searching unit 1205 can thereby search the storage area 402 of the storage device D for the repair data for repairing the file to which data anomaly occurs and that has the file name “bbb.doc” with the associated data ID included in the acquisition request R3 used as a clue.

Fourth Search Process

In the fourth search process, it is assumed that even if the older restoration point is deleted, the restoration point information corresponding to the deleted restoration point is not deleted from the restoration point table 900.

The searching unit 1205 identifies the restoration point ID of the restoration point generated just before or just after the date at which the restoration point having the restoration point ID corresponding to the data ID included in the acquisition request R3 is generated by referring to the restoration point table 900.

When identifying the restoration point ID, the searching unit 1205 searches the save information table 1000 for the save information in which the restoration point ID is set to the restoration point ID field, “bbb.doc” is set to the file name field, and “D:¥test¥pro¥” is set to the path name.

The searching unit 1205 searches the storage area 402 of the storage device D for the file having the save destination file name included in the retrieved save information. If the file is retrieved, the searching unit 1205 determines, for example, whether the size and the hash value of the retrieved file match the size “126,889” and the hash value “ . . . ” (a value obtained by the hash function), respectively.

If the sizes and the hash values match one another, the searching unit 1205 determines the retrieved file as the repair data. The searching unit 1205 can thereby search the storage area 402 of the storage device D for the repair data for repairing the file to which data anomaly occurs and that has the file name “bbb.doc” with the restoration point ID of the restoration point generated just before or just after the restoration point corresponding to the data ID included in the acquisition request R3 used as a clue.

While it has been explained above that the restoration point generated by the copying unit 1202 is searched for, the search target is not limited to the restoration point. For example, when a restoration point generated by a user or an OS of the backup target machine M is present, the searching unit 1205 can search for the restoration point generated by the user or the OS as the search target.

Procedures of various processes performed by the backup server 301 are explained next. Procedures of the backup process performed by the backup server 301 are explained first.

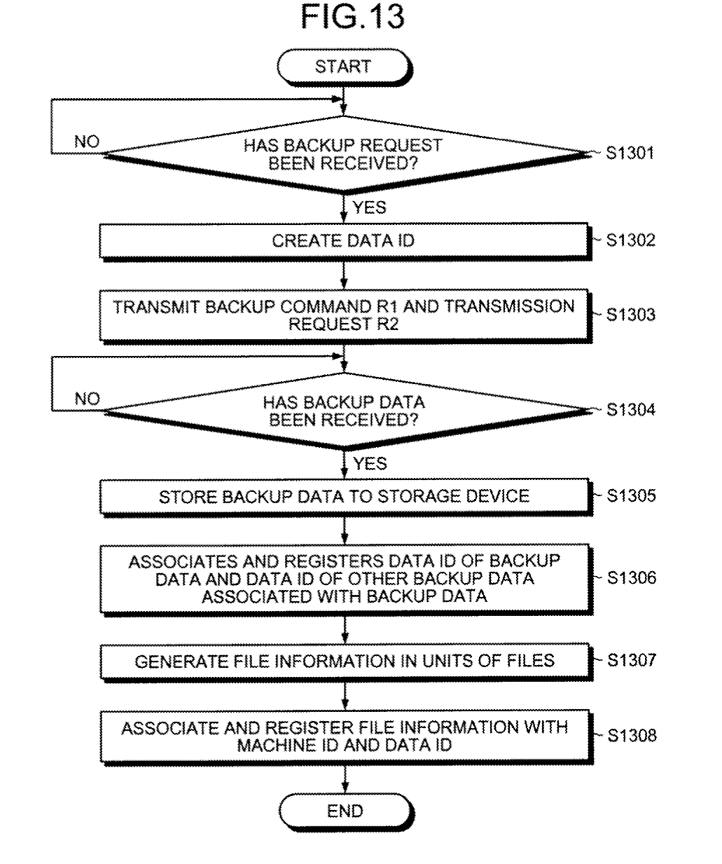

FIG. 13 is a flowchart depicting an example of the procedures of the backup process performed by the backup server 301. In the flowchart depicted in FIG. 13, the backup server 301 first determines whether the backup server 301 has received the backup request to back up the target data stored in the storage device D of one of the backup target machines M (step S1301).

The backup server 301 waits for the backup request to be received (step S1301: NO). Upon receiving the backup request (step S1301: YES), the backup server 301 creates the data ID that uniquely identifies the backup data of the target data (step S1302).

The backup server 301 transmits the backup command R1 to back up the target data and the transmission request R2 to transmit the backup data of the target data to the backup target machine M (step S1303). The backup server 301 determines whether the backup server 301 has received the backup data of the target data from the backup target machine M (step S1304).

The backup server 301 waits to receive the backup data (step S1304: NO). Upon receiving the backup data (step S1304: YES), the backup server 301 stores the backup data of the target data to the storage device 302 based on the received backup data (step S1305). The backup server 301 can generate files as the backup image by merging together the received backup data in units of blocks.

The backup server 301 associates and registers the data ID of the stored backup data and the data ID of the other backup data associated with the stored backup data into the data association table 700 (step S1306). The backup server 301 generates the file information in units of files on the target data from the stored backup data (step S1307).

Finally, the backup server 301 registers the generated file information in units of files, the machine ID of the backup target machine M, and the data ID of the backup data in the file information table 800 while associating the file information with the machine ID and the data ID of the backup data (step S1308), and ends a series of procedures of the backup process according to the flowchart depicted in FIG. 13.

The backup server 301 can thereby hold the target data stored in the storage device D of the backup target machine M in the storage device 302, and transmit the backup command R1 to back up the target data to the backup target machine M.

Procedures of a verification process performed by the backup server 301 are explained next. The verification process is a process for verifying backup data having a certain data ID. For example, the backup server 301 performs this verification process at a regular interval, before performing the backup process, before performing a restoration process, or at user's arbitrary timing.

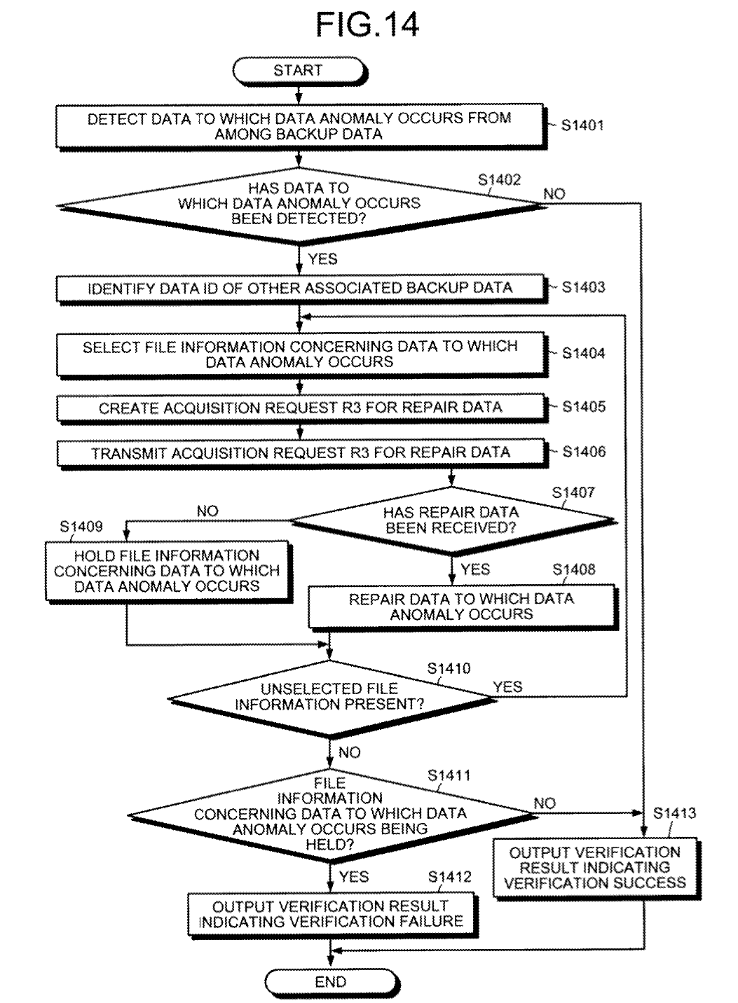

FIG. 14 is a flowchart depicting an example of the procedures of the verification process performed by the backup server 301. In the flowchart depicted in FIG. 14, the backup server 301 first detects the data to which data anomaly occurs from among the backup data by referring to the file information table 800 (step S1401).

Next, the backup server 301 determines whether the backup server 301 has detected the data to which data anomaly occurs (step S1402). If the data to which data anomaly occurs is not detected (step S1402: NO), the backup server 301 moves to step S1413.

On the other hand, if the data to which data anomaly occurs is detected (step S1402: YES), the backup server 301 identifies the data ID of the other backup data associated with the backup data by referring to the data association table 700 (step S1403).

Subsequently, the backup server 301 selects the file information concerning the data to which data anomaly occurs from the file information table 800 (step S1404). The backup server 301 creates the acquisition request R3 to acquire the repair data for repairing the data to which data anomaly occurs based on the selected file information (step S1405).

Next, the backup server 301 transmits the created acquisition request R3 to transmit the repair data to one of the backup target machines M (step S1406). The backup server 301 determines whether the backup target machine M has received the repair data for repairing the data to which data anomaly occurs (step S1407).

If the backup target machine M has received the repair data (step S1407: YES), the backup server 301 repairs the data to which data anomaly occurs based on the received repair data (step S1408). If the backup target machine M has not received the repair data (step S1407: NO), the backup server 301 holds in the memory 502, the file information concerning the data to which data anomaly occurs (step S1409).

Next, the backup server 301 determines whether unselected file information concerning the data to which data anomaly occurs and that is not selected from the file information table 800 is present (step S1410). If unselected file information is present (step S1410: YES), the backup server 301 returns to step S1404.

Meanwhile, if no unselected file information is present (step S1410: NO), the backup server 301 determines whether file information concerning the data to which data anomaly occurs is held in the memory 502 (step S1411).

If the file information concerning the data to which data anomaly occurs is held in the memory 502 (step S1411: YES), the backup server 301 outputs a verification result indicating a failure in the verification of the backup data (step S1412), and ends a series of procedures of the verification process according to the flowchart depicted in FIG. 14.

Examples of the form of output of the verification result from the backup server 301 include display of the verification result on the display 505, printout at a printer (not depicted), and transmission to the external computer by the use of the I/F 504. Alternatively, the verification result can be stored to the memory 502, the auxiliary storage device 503, or the like.

On the other hand, if file information concerning the data to which data anomaly occurs is not held in the memory 520 (step S1411: NO), the backup server 301 outputs a verification result indicating success in the verification of the backup data (step S1413), and ends a series of procedures of the verification process according to the flowchart depicted in FIG. 14.

The backup server 301 can thereby verify the verification target backup data. If the backup data includes the data to which data anomaly occurs, the backup server 301 can acquire the repair data from the backup target machine M and repair the data to which data anomaly occurs.

The verification result indicating the failure in the verification of the backup data can include the file information concerning the data to which data anomaly occurs. For example, a user of the backup server 301 can thereby grasp the data that is included in the backup data and to which data anomaly occurs in units of files.

Procedures of various processes performed by each of the backup target machines M are explained next. Procedures of a backup process performed by each of the backup target machines M are explained first.

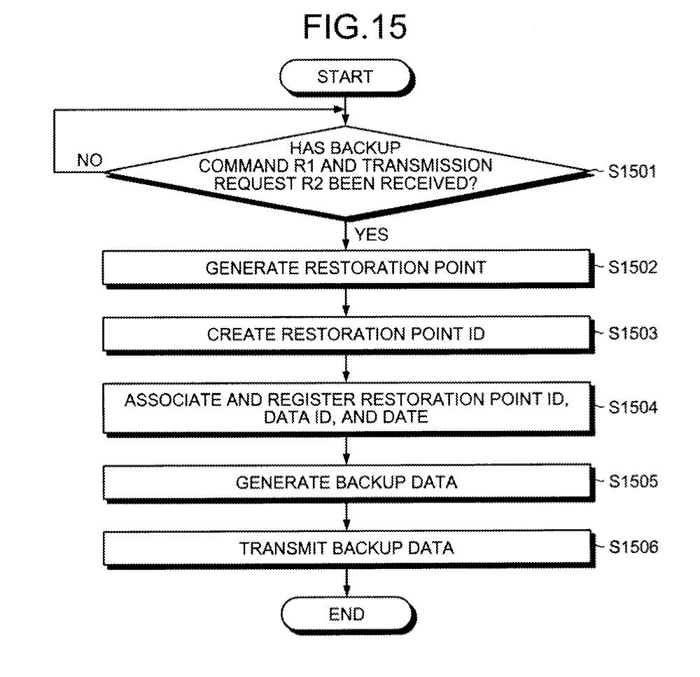

FIG. 15 is a flowchart depicting an example of the procedures of the backup process performed by the backup target machine M. In the flowchart depicted in FIG. 15, first, the backup target machine M determines whether the backup target machine M has received the backup command R1 and the transmission request R2 from the backup server 301 (step S1501).

The backup server machine M waits to receive the backup command R1 and the transmission request R2 (step S1501: NO). Upon receiving the backup command R1 and the transmission request R2, the backup target machine M generates a restoration point (step S1502).

Next, the backup target machine M creates the restoration point ID that uniquely identifies the generated restoration point (step S1503). The backup target machine M registers the created restoration point ID, the data ID of the backup data included in the backup command R1, and the date at which the restoration point is generated in the restoration point table 900 while associating the restoration point ID, the data ID of the backup data, and the date with one another (step S1504).

Subsequently, the backup target machine M generates the backup data of the target data (step S1505). The backup target machine M transmits the generated backup data to the backup server 301 (step S1506), and ends a series of procedures of the backup process according to the flowchart depicted in FIG. 15.

The backup target machine M can thereby transmit the backup data of the target data stored in the storage device D of the backup target machine M to the backup server 301, and back up the target data.

Procedures of a repair-data transmission process performed by each of the backup target machines M are explained next.

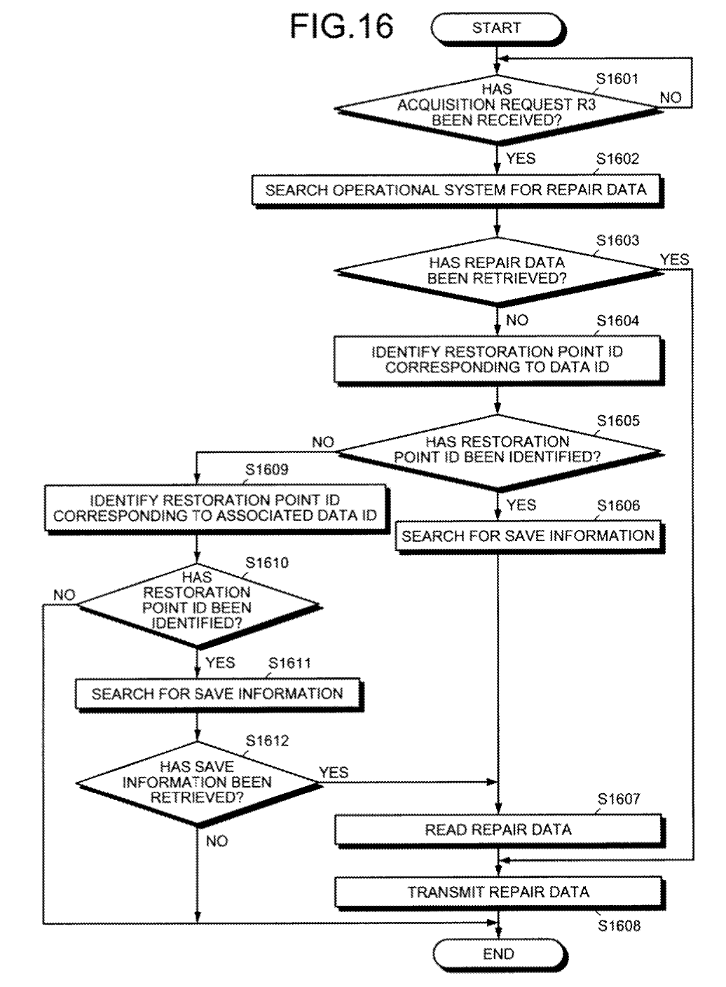

FIG. 16 is a flowchart depicting the procedures of the repair-data transmission process performed by each of the backup target machines M. In the flowchart depicted in FIG. 16, the backup target machine M determines whether the backup target machine M has received the acquisition request R3 to acquire the repair data for repairing the data to which data anomaly occurs from the backup server 301 (step S1601).

The backup target machine M waits to receive the acquisition request R3 (step S1601: NO). Upon receiving the acquisition request R3 (step S1601: YES), the backup target machine M searches an operational system for the repair data identified from the acquisition request R3 (step S1602). The operational system is the storage area used by the OS of the backup target machine M, for example, the storage area 401 of the storage device D.

Next, the backup target machine M determines whether the backup target machine M has retrieved the repair data (step S1603). Upon retrieving the repair data (step S1603: YES), the backup target machine M moves to step S1608. If the repair data is not retrieved (step S1603: NO), the backup target machine M identifies the restoration point ID corresponding to the data ID included in the acquisition request R3 by referring to the restoration point table 900 (step S1604).

The backup target machine M determines whether the backup target machine M has identified the restoration point ID (step S1605). Upon identifying the restoration point ID (step S1605: YES), the backup target machine M searches the save information table 1000 for the corresponding save information (step S1606).

Subsequently, the backup target machine M reads the repair data from the storage area 402 of the storage device D by referring to the retrieved save information (step S1607). The backup target machine M transmits the read repair data to the backup server 301 (step S1608), and ends a series of procedures of the repair-data transmission process according to the flowchart depicted in FIG. 16.

If the restoration point ID is not identified (step S1605: NO), the backup target machine M identifies the restoration point ID corresponding to the associated data ID included in the acquisition request R3 by referring to the restoration point table 900 (step S1609). The backup target machine M determines whether the backup target machine M has identified the restoration point ID (step S1610).

If the restoration point ID is not identified (step S1610: NO), the backup target machine M ends a series of procedures of the repair-data transmission process according to the flowchart depicted in FIG. 16. If the restoration point ID is identified (step S1610: YES), the backup target machine M searches the save information table 1000 for the corresponding save information (step S1611). The backup target machine M determines whether the backup target machine M has retrieved the save information (step S1612).

If the save information is retrieved (step S1612: YES), the backup target machine M moves to step S1607. If the save information is not retrieved (step S1612: NO), the backup target machine M ends a series of procedures of the repair-data transmission process according to the flowchart depicted in FIG. 16.

The backup target machine M can thereby search the storage device D for the repair data for repairing the data that is included in the backup data and to which data anomaly occurs, and transmit the retrieved repair data to the backup server 301.

As described above, the backup server 301 according to the second embodiment can transmit the backup command R1 to back up the target data and the transmission request R2 to transmit the backup data of the target data to each of the backup target machines M. When receiving the backup data as a result of transmission of the backup command R1 and the transmission request R2, the backup server 301 can store the backup data in the storage device 302 while associating the backup data with the data ID of the backup data.

The backup target machine M according to the second embodiment can back up the target data while associating the target data with the data ID of the backup data and transmit the backup data to the backup server 301 when receiving the backup command R1 and the transmission request R2. Both the backup server 301 and the backup target machine M can thereby hold the target data stored in the storage device D of the backup target machine M, thereby making it possible to make the backup data redundant.

Furthermore, the backup target machine M can suppress an increase in the storage capacity required to back up the target data by performing a backup of the target data by using the snapshot function based on the copy-on-write method.

The backup server 301 can transmit the acquisition request R3 to acquire the repair data for repairing the data to which data anomaly occurs to the backup target machine M when having detected the data to which data anomaly occurs from the verification target backup data. The backup target machine M can search the storage device D for the repair data identified from the acquisition command R3 and transmit the repair data to the backup server 301.

For example, the backup target machine M can search the storage area 401 of the storage device D for the repair data with the file name, the path name, the date, the size, and the hash value included in the acquisition request R3 used as a clue. The backup target machine M can thereby search the operational system for the target data that has been never updated since receiving the backup command R1 from the backup server 301. The operational system refers to the storage area used by the OS of the backup target machine, for example, the storage area 401 of the storage device D.

For example, the backup target machine M can search the storage area 402 of the storage device D for the repair data with the data ID included in the acquisition request R3 used as a clue. The backup target machine M can thereby search the data that is backed up to be associated with the data ID of the backup data for the repair data.

For example, the backup target machine M can search the storage area 402 of the storage device D for the repair data with the associated data ID included in the acquisition request R3 used as a clue. The backup target machine M can thereby search the data that is backed up to be associated with the data ID of the other backup data associated with the backup data for the repair data in a case where the restoration point generated in response to the backup command R1 is deleted or the like.

With the above configuration, the backup server 301 can repair the backup data to which data anomaly occurs by using the backup data held in the backup target machine M. As a result, in a case where data anomaly subsequent occurs to the target data stored in the storage device D or the like, it is possible to repair the target data stored in the backup target machine to which data anomaly occurs by using the backup data repaired by the backup server 301.

The backup control method described in the present embodiment may be implemented by executing a prepared program on a computer such as a personal computer and a workstation. The program is stored on a computer-readable recording medium such as a hard disk, a flexible disk, a CD-ROM, an MO, and a DVD, read out from the computer-readable medium, and executed by the computer. The program may be distributed through a network such as the Internet.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A computer-readable recording medium storing a program causing a computer to execute a backup control process comprising:
transmitting to a controlled device, a backup command to back up target data stored in the controlled device having a backup unit that backs up data while associating the data with identification information of duplicated data that is a copy of the data, and a transmission request to transmit duplicated data of the target data; and
storing the duplicated data to a storage unit while associating the duplicated data with the identification information concerning the duplicated data upon receiving the duplicated data and the identification information concerning the duplicated data as a result of transmitting the backup command and the transmission request.

2. The computer-readable recording medium according to claim 1, wherein
the transmitting includes transmitting to the controlled device, the identification information concerning the duplicated data of the target data, and
the storing includes storing the duplicated data to the storage unit while associating the duplicated data with the identification information concerning the duplicated data upon receiving the duplicated data as a result of transmitting the backup command, the transmission request, and the identification information concerning the duplicated data.

3. The computer-readable recording medium according to claim 1, of the backup control process comprising:
transmitting to the controlled device upon detecting that data anomaly occurs to the duplicated data stored in the storage unit, the identification information associated and stored with the duplicated data in the storage unit; and
receiving from the controlled device and among the data backed up by the backup unit, the data backed up to be associated with the transmitted identification information.

4. The computer-readable recording medium according to claim 3, the process comprising repairing the duplicated data based on the data backed up to be associated with the identification information concerning the duplicated data, the duplicated data being repaired upon receiving from the controlled device, the data backed up to be associated with the identification information concerning the duplicated data.

5. The computer-readable recording medium according to claim 3, the process comprising:
identifying identification information concerning other duplicated data associated with the duplicated data by referring to association information that associates and indicates the identification information concerning the duplicated data and the identification information concerning the other duplicated data associated with the duplicated data; and
transmitting the identified identification information concerning the other duplicated data to the controlled device upon detecting that the data anomaly occurs to the duplicated data, wherein
the receiving includes receiving from the controlled device and from among the data backed up by the backup unit, the data backed up to be associated with the identification information concerning the other duplicated data.

6. A backup control method executed by a computer, the backup control method comprising:
transmitting to a controlled device, a backup command to back up target data stored in the controlled device having a backup unit that backs up data while associating the data with identification information of duplicated data that is a copy of the data, and a transmission request to transmit duplicated data of the target data; and
storing the duplicated data to a storage unit while associating the duplicated data with the identification information concerning the duplicated data upon receiving the duplicated data and the identification information concerning the duplicated data as a result of transmitting the backup command and the transmission request.

7. The backup control method according to claim 6, wherein:
the transmitting includes transmitting to the controlled device, the identification information concerning the duplicated data of the target data; and
the storing includes storing the duplicated data to the storage unit while associating the duplicated data with the identification information concerning the duplicated data upon receiving the duplicated data as a result of transmitting the backup command, the transmission request, and the identification information concerning the duplicated data.

8. A backup control device comprising a computer configured to:
transmit to a controlled device, a backup command to back up target data stored in the controlled device having a backup unit that backs up data while associating the data with identification information of duplicated data that is a copy of the data, and a transmission request to transmit duplicated data of the target data; and
store the duplicated data to a storage unit while associating the duplicated data with the identification information concerning the duplicated data upon receiving the duplicated data and the identification information concerning the duplicated data as a result of transmitting the backup command and the transmission request.

9. The backup control device according to claim 8, wherein
the computer transmits to the controlled device, the identification information concerning the duplicated data of the target data; and
the computer stores the duplicated data to the storage unit while associating the duplicated data with the identification information concerning the duplicated data upon receiving the duplicated data as a result of transmitting the backup command, the transmission request, and the identification information concerning the duplicated data.
